(19) United States
(12) Patent Application Publication
(10) Pub. No.: US 2016/0319737 A1
(43) Pub. Date: Nov. 3, 2016

(54) PISTON ENGINE WITH SUPPORT PISTON

(71) Applicant: FEV GMBH, Aachen (DE)

(72) Inventors: Uwe Schaffrath, Herzogenrath (DE); Mike Souren, Ex-Vaals (NL); Klaus Turiaux, Aachen (DE)

(73) Assignee: FEV GmbH, Aachen (DE)

(21) Appl. No.: 15/105,246

(22) PCT Filed: Dec. 18, 2014
(86) PCT No.: PCT/EP2014/078505

§ 371 Date: Jun. 16, 2016

(30) Foreign Application Priority Data
Dec. 18, 2013 (DE) 102013021065.8

(51) Int. Cl. F02B 75/04; F01M 1/06; F16C 7/06; F02F 3/00; F02D 15/02

(52) U.S. Cl. CPC F02B 75/045; F02F 3/00; F02D 15/02; F16C 7/06; F01M 1/06; F01M 2001/066

(57) ABSTRACT

A piston engine having a crankshaft and at least one connecting rod which corotates with the crankshaft, wherein the connecting rod has a small eye and a large eye. The connecting rod has a compression piston, preferably a combustion chamber piston, which is arranged on the connecting rod and can be adjusted eccentrically by means of an eccentric member and an adjusting system, preferably an adjusting linkage. The adjusting system is supported by means of at least one support piston which can be moved in a support cylinder of the connecting rod, wherein the support cylinder and the support piston form a specific leakage path. Oil of the piston engine counteracts a movement of the support piston as damping medium in the support cylinder, wherein the oil can flow along the specific leakage path between the support piston and the support cylinder.

### CROSS-REFERENCE TO RELATED APPLICATIONS

This application is the U.S. national stage of PCT/EP2014/078505 filed Dec. 18, 2014, which claims priority of German Patent Application 10 2013 021 065.8 filed Dec. 18, 2013.

### FIELD OF THE INVENTION

The present invention relates to a piston engine with variable compression stroke, also referred to as “variable compression rate” piston engine, or VCR piston engine for short, and to a method for variation of the compression stroke in a piston engine. The piston engine is preferably an internal combustion engine of a road-going vehicle, and therefore preferably has at least two cylinders with respective adjustment mechanisms. A connecting rod of the piston engine has not only an eccentrically adjustable compression piston but at least one support piston which, via an adjustment system, offers support for the eccentric adjustment of the compression piston.

### BACKGROUND OF THE INVENTION

The requirement for piston engines to be utilizable in the most optimized manner possible in different ranges has the effect that, inter alia, the piston stroke should be variably adjustable. In this way, the piston stroke can be varied in a manner suitable for every usage situation of the piston engine. If the piston engine is in turn used in operation in different ranges, for example load ranges, this can also be allowed for by way of an adjustment of the stroke and thus of the resulting compression.

In the prior art, there is a multiplicity of different solutions for a variation of the compression during operation. For example, DE 10 2007 040 699 A1 presents a magnetic solution. Here, however, the initial situation on which the invention is based proceeds from a piston engine such as emerges from DE 10 2005 055 199 A1. The content of said document is hereby referred to with regard to the scope of the disclosure, because the basic construction of the piston engine and of a special connecting rod that may possibly be used, and also the basic adjustment method, emerge from said document.

### SUMMARY OF THE INVENTION

It is an object of the present invention to make it possible to realize an improved adjustment characteristic during a variation of the compression ratio in the case of a generic piston engine.

A piston engine with variable compression stroke is proposed, comprising
a crankshaft,
at least one connecting rod which co-rotates with the crankshaft, wherein the connecting rod has a small and a large eye,
a compression piston, preferably a combustion chamber piston, which is arranged on the connecting rod and which is eccentrically adjustable by way of an eccentric member and an adjustment system, preferably an adjustment linkage, wherein the adjustment system is supported by way of at least one support piston which is movable in a support cylinder of the connecting rod,
   characterized in that
the support cylinder and the support piston form a targeted leakage path.

The support piston is supported on a medium in the support cylinder. The medium is preferably a lubricant which is also used at other locations in the rest of the piston engine. Therefore, the eccentric member is preferably arranged in the small connecting-rod bearing eye, wherein the compression piston is arranged rotatably in the eccentric member. The piston engine may have one or more such connecting rods arranged on the crankshaft. In principle, an adjustment can be performed as emerges from DE 10 2005 055 199 A1, as already discussed above in the prior art, or else from DE 10 2012 014 917 A1 or DE 10 2011 108 790 A1, to the entire content of which reference is hereby made, in the context of the disclosure, in this regard but also in regards to the adjustment and construction of the piston engine and of the connecting rod together with support cylinder and support piston.

While the support cylinder receives the medium on which the support piston is supported, the support piston in interaction with the support cylinder divides the content of the support cylinder, for example into a medium-filled support chamber and an adjustment chamber into which the support piston moves when an eccentric adjustment of the compression piston is to be performed. The adjustment chamber is preferably not filled with the medium, wherein embodiments are however also possible in which the adjustment chamber is also at least partially filled with the medium. The adjustment chamber is preferably filled with air. It is now provided that a targeted leakage path, preferably for the medium, is provided between the support cylinder and the support piston. It has been found that, by way of the leakage path and the targeted adjustment thereof, it is for example possible to prevent the support piston from retracting ever further over the course of time and thus giving rise to an undesired adjustment of the eccentricity. A further advantage may for example be that the ventilation is provided by way of the targeted leakage path. For example, if foam or else air bubbles collect in the supporting medium, it is possible by way of the targeted leakage path for a flow to pass by in a gap between support cylinder and support piston.

The leakage path is preferably only intermittently open. For example, the intermittent opening-up may be associated with a movement is the support piston. In one embodiment, the leakage path is least partially targetedly opened up during a movement of the support piston in each case in a first direction and also in the opposite second direction. This may be the case for example during the entire movement or else only during a part of the movement. The leakage path may for example be opened up over its entire length simultaneously. Said leakage path may however also be opened up in sections or gradually. It is also possible for the leakage path to be subject to a certain arbitrariness with regard to its profile between support piston and support cylinder. For example, the way in which the leakage path forms may be dependent on the movement. Here, the leakage path is defined in particular by the geometry of the support cylinder, of the support piston, and by the relative movement thereof with respect to one another in an axial direction and in a radial direction. By contrast, a further embodiment provides for the leakage path to be defined by way of a predefined, fixed path along which the medium must flow. Both embodiments relating to the leakage path may also be combined with one another. It is thus possible for different regions between support piston and support cylinder to each define the leakage path differently.

A further embodiment, which may be used together with or independently of the other described embodiments, provides a piston engine in which the support piston is provided without a separate sealing element between support piston and support cylinder, and moves along the support cylinder without a sealing element.

An advantage in the utilization of a support piston without sealing element is for example a minimization of the friction between support piston and support cylinder. This is advantageous for example with regard to the switching times, in particular at low engine speeds, in particular also in the direction of “high epsilon”, that is to say high compression ratio, because the inertia forces, on which the adjustment system is reliant for adjustment, are only low in this situation.

A preferred configuration of the defined leakage path is for example performed as follows:

For a gap leakage of an eccentric ring-shaped gap, the following mathematical equation is taken as a basis:

$${Q}_{L} = \frac{π \cdot {d}_{m} \cdot {h}^{3} \cdot Δ p}{12 \cdot η \cdot l} \cdot [ 1 + \frac{3}{2} {( \frac{e}{h} )}^{2} ]$$

where dₘ=mean diameter of the sealing point, h=gap height, 1=length of the sealing point, η=dynamic viscosity, and e=eccentricity.

A difference in diameter between the support piston and the support cylinder is dimensioned such that the leakage remains very low but jamming of the piston cannot occur. Here, the leakage path will change as a result of the movement of the support piston. By way of a suitable configuration of the fit between support piston and support cylinder, it is possible to make do without a separate sealing means between support piston and support cylinder.

In one refinement, it is provided that sinking of the support cylinder by 1% . . . 2% or more in relation to the total movement travel, which is equal to the stroke of the support mechanism, can be accepted. It has accordingly been found, for example, that sinking by approximately 0.3 mm in the case of an approximately 30 mm support piston stroke does not lead to falsification of the eccentricity of the compression piston to such an extent as to ultimately yield, in the case of permanent repetition, an entirely incorrect position of the compression piston.

A diameter difference between support piston and support cylinder is preferable which, for this purpose, for example on the gas force side, amounts to approximately 0.1% . . . 0.2% in relation to the nominal diameter of the support cylinder. Here, the gas force side is that which, during a movement of the connecting rod owing to the acting combustion and expansion in the case of an internal combustion engine, for example, acts as a pressure force on the compression piston but also on the support piston as an adjustment force in the direction of action of the gas force. For example, for a diameter of 14 mm, a diametric clearance of approximately 0.025 mm is provided.

In one embodiment, it is for example provided that the support piston and support cylinder are paired in targeted fashion by way of a classification. The classification may for example be associated with a precise surface measurement and contour determination, which makes it possible to identify those pairs which actually also conform to the corresponding diameter difference along the movement travel of the support piston. The support cylinder surface must, in terms of shape and surface condition, be suitable for a sealing concept, wherein said support cylinder surface is preferably honed, subjected to precision spindle-forming, or ground. Laser surface machining is likewise possible.

One refinement provides that a relatively large clearance is accepted on the inertia force side, because it is normally the case that a relatively low oil pressure prevails here.

Furthermore, a piston engine is proposed in which the co-rotating connecting rod has a first and a second support piston which have different diameters in relation to one another, wherein the first support piston has a relatively small diameter and, between the first support piston and the first support cylinder associated therewith, there is a first gap which is larger than that between the second support piston and the second support cylinder associated therewith.

Such an arrangement can preferably be adapted to the difference between inertia force side and gas side, in particular to the pressures thereby exerted. The relatively small diameter is preferably arranged on the side at which relatively low pressures act.

The peak combustion pressure and the inertia forces in the crank drive are reflected in the support cylinder pressures by way of the geometric conditions such as in particular eccentricity, lever length, force action angle of the support rods, and support piston diameter. Oil pressures in the gas force-side support cylinder may by all means reach 300 bar or higher. One embodiment provides that pressures of over 400 bar are generated. A preferred embodiment provides utilization of a defined leakage path without sealing element between support piston and support cylinder, wherein pressures of over 400 bar may arise in the support cylinder.

A support piston height is incorporated preferably only linearly in the configuration equation specified above. Therefore, it is of lower value than the diametric clearance. Nevertheless, the support piston height should be dimensioned to be as large as possible, wherein a height of between approximately 0.8 and 1.5×D has proven to be advantageous.

A further embodiment provides that at least the support piston may be coated, for example coated with graphite, in order to minimize the clearance between support piston and support cylinder. A piston engine is preferably proposed in which the support piston has, on its circumference, a coating, preferably a run-in coating, owing to which the support piston must firstly be forced under pressure into the support cylinder and which abrades during operation in order to thereby realize a gap between the support piston and the support cylinder, and/or preferably a protective coating which exhibits greater abrasion resistance than the support piston material itself.

It is for example possible, in an embodiment of said type, for relatively large manufacturing tolerances to be planned in, because the run-in coating can function as a sacrificial layer and thus bridges the clearance.

A further embodiment of the piston engine provides that the support piston is equipped with a sealing element which permits targeted leakage, preferably via a parting in a joint region of the sealing element and via an axial clearance between, on the one hand, a height of the sealing element and, on the other hand, a groove height of a groove in which the sealing element is arranged.

A sealing element which can ensure targeted leakage provides, for example, a sealing ring composed of plastic which has a diagonal parting at a joint required for installation purposes. By way of the angle of the joint and the axial clearance, that is to say of sealing ring height with respect to groove height, it is possible for a leakage flow, for example for ventilation purposes, to be set by way of this form of definition of the leakage path.

A further embodiment provides that the support piston has one or more at least partially encircling channels along its outer circumference. The support piston may preferably be formed with small grooves on the outer side. These ensure an additional sealing action, because the leakage flow is turbulent here.

A refinement which may however also be independent of other embodiments provides a piston engine in which the support piston is connected to an element of the adjustment linkage by way of a ball head connection. The connection between a support rod of the adjustment linkage and the support piston is preferably formed as a ball head connection. This may in particular be realized in the form of a miter-shaped contour. In this way, the effective sealing length is not interrupted by a bolt.

In order that the Hertzian stresses remain as low as possible, the following is proposed for the ball head connection:
a ball diameter should be as large as possible, that is to say a contact length of the linear contact should be maximized;
this however must not have the effect that the walls of the support piston become so thin that the deformations lead to jamming;
a ratio of ball diameter to support piston diameter should preferably lie in a range from 0.70 to 0.85.

For this purpose, one embodiment provides that the piston engine has a support piston with an internal contour of spherical form, against which a head of the ball head connection lies. The contact surface may for example have a friction-reducing coating.

It is furthermore preferable if the piston engine has an end-side external contour of the support piston, said external contour being of spherical form. The support piston contour may be of spherical form, whereby the jamming tendency in the presence of small clearances is reduced.

A further refinement provides that the piston engine has at least one support piston with a geometry which permits flaring of the support piston upon exertion of pressure via the adjustment linkage, wherein a gap spacing between an internal surface of the support cylinder and an opposite external surface of the support piston is reduced.

In conjunction with the ball head, it is also possible for an additional ventilation bore to be formed into the piston, because the ball seat has a sealing action under pressure. For this situation, it is for example provided that no air can be sucked in in a backward direction. This is preferably achieved in that, at those times in the cycle at which a tensile force acts on the support rods, the medium pressure in the support cylinders is in any case greater than the pressure in the crankcase.

A further embodiment provides a piston engine in which the support piston has a ventilation bore extending all the way through, one end of which opens out, in a region of a piston end side of the support piston, into a first side of the support cylinder and the other end of which opens out into a second side of the support cylinder, wherein the first and the second side of the support cylinder are separated from one another by the support piston.

The piston engine is preferably used in the form of an internal combustion engine of a road-going vehicle, wherein the internal combustion engine has an adjustable stroke for compression variation during operation through utilization of the at least one eccentrically adjustable combustion chamber piston, wherein at least one eccentric adjustment can be performed by way of gas and/or inertia forces acting on the at least one adjustment linkage.

The proposed piston engine preferably has an embodiment in which the co-rotating connecting rod has a first and a second support piston which are connected to one another by way of the adjustment linkage, wherein the first support piston is connected to the adjustment linkage by way of a ball head connection, and the second support piston is connected to the adjustment linkage by way of a bolted connection.

According to a further concept of the invention, which can preferably be implemented for example using one of the piston engines proposed above, a method for the adjustment of a compression of a piston engine by way of an eccentrically adjustable piston stroke is proposed, wherein the adjustment of the piston stroke takes place through the utilization of acting inertia and/or gas forces which, for this purpose, act on an adjustment linkage and on a support piston arranged on said adjustment linkage, wherein the support piston moves in a support cylinder, wherein, in the support cylinder, oil of the piston engine as damping medium counteracts a movement of the support piston, wherein the oil can flow between the support piston and the support cylinder along a targeted leakage path.

A further embodiment of a concept of the invention relates to a method, which can preferably also be implemented together with the method above, for the adjustment of a compression of a piston engine, preferably with an above-described embodiment of a piston engine, wherein the adjustment of the piston stroke takes place through the utilization of acting inertia and/or gas forces which, for this purpose, act on an adjustment linkage and on a support piston arranged on said adjustment linkage, wherein the support piston moves in a support cylinder, wherein, in the support cylinder, oil of the piston engine as damping medium counteracts a movement of the support piston, wherein, at a breakaway torque of 0.7 Nm or lower, friction between the support piston and support cylinder is overcome, and an adjustment of the support piston in the support cylinder takes place.

The breakaway torque at the support piston is preferably relatively high during the initial operation of the piston engine, and slowly decreases with progressive use of the piston engine. In particular, a stiffness, for example of a sealing element, can decrease as a result of a pressure acting in the support cylinder. At low engine speeds of for example 1000 rpm, a breakaway torque may be approximately 0.7 Nm at TDC.

### BRIEF DESCRIPTION OF THE DRAWINGS

FIG. 1 is cross-sectional view of a piston with a support piston according to the invention;

FIG. 1A is a fragmentary view of a support piston and sealing element permitting leakage in accordance with the invention;

FIG. 2 is a cross-sectional view of a support piston with a ball head connection in accordance with a first alternative embodiment of the invention;

FIG. 3 is a cross section of a support piston having a spherical end surface in accordance with a second alternative embodiment;

FIG. 4 is a cross section of a support cylinder having an encircling recess in accordance with a third alternative embodiment of the invention;

FIG. 5 is a perspective view of support pistons having different diameters in accordance with a fourth alternative embodiment of the invention.

### DETAILED DESCRIPTION OF THE INVENTION

Further advantageous embodiments and refinements will emerge from the following figures. The embodiments that emerge from the respective figures serve in each case for the explanation of the invention, without being intended to restrict the invention, however. Rather, it is possible for one or more embodiments to be combined with one another, and for one or more features from one figure or from the above description to be combined with one or more features from another figure or from the above description to form further embodiments.

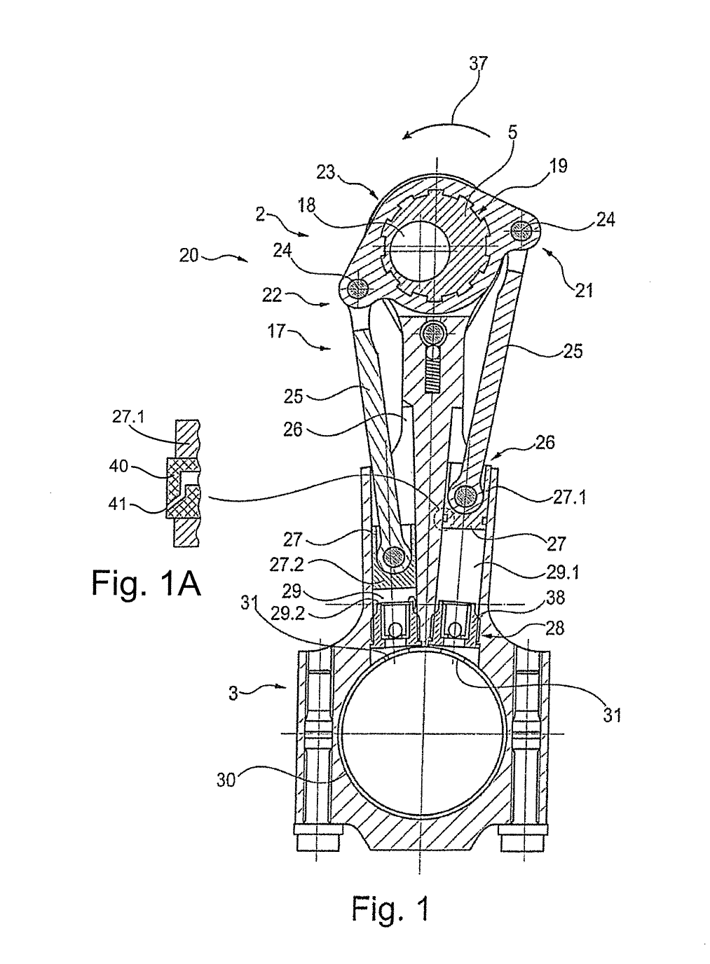

FIG. 1 shows an embodiment which permits adjustable variation of a compression ratio in a piston engine 1 in the form of a reciprocating-piston internal combustion engine. Below, the same reference designations are used for identical components. The connecting rod 17 has a large connecting-rod bearing eye 3 and a small connecting-rod bearing eye 2. In the small connecting-rod bearing eye 2 there is arranged, in turn, a rotatably mounted sleeve or eccentric member 5. The eccentric 5 has a bore 18 for receiving a piston pin. On an external surface, the eccentric 5 has a toothing 19. By way of said toothing 19, the eccentric 5 is connected to a lever system 20 which acts as a support mechanism and preferably also as a non-return device. The lever system 20 has a first lever 21 and a second lever 22. By way of the lever system 20, the two levers 21, 22 are fixedly coupled to one another. In turn, by way of the toothing 19, the levers 21, 22 are thus also connected rotationally conjointly to the eccentric 5. The lever system 20 with the levers 21, 22 is arranged in a recess 23 in the second connecting rod 17. It can also be seen from FIG. 1 that the lever system 20 is guided axially in the recess 23. Furthermore, the lever system 20 has connecting joints 24. Rods 25 are articulatedly connected by way of the connecting joints 24. In turn, in the second connecting rod 17, there are arranged support cylinder bores 26. Support pistons 27 to which the rods 25 are articulatedly connected are guided in said support cylinder bores. Owing to this arrangement, a respective stroke of the two support pistons is in a direct relationship with respect to an angle of rotation of the eccentric 5. The support cylinder bores 26 in the connecting rod 17 are closed off in the direction of the large connecting-rod bearing eye 3 by way of check valves 28, such that in each case one working chamber 29 is formed. The working chamber can thus serve as a damping volume and as a support in the case of a non-return device. Connecting-rod bearing shells 30 are arranged in the large connecting-rod bearing eye 3. The connecting-rod bearing shells 30 are provided with apertures 31. Since the bearing shells 30 are provided with an encircling groove which is connected to an oil supply via the crankshaft, an oil pressure prevails in the groove at all times. Said oil pressure is transmitted at all times to the check valves 28. These open, or are closed, in a manner dependent on the working pressure prevailing in the working chamber 29. The exact process of a possible variation of the compression ratio otherwise emerges in more detail from the prior art cited above, in particular for example from DE 10 2005 055 199 A1.

The functioning of the connecting rod 17 for the purposes of setting a different compression ratio will be discussed by way of example below, on the basis of the example of the setting of a low compression ratio. If, during engine operation, a low compression ratio is desired, it is for example the case that a 3/2 directional valve is placed into a particular position. In engine phases in which pressure forces act on the connecting rod 17, a pressure builds up in the first working chamber 29.1. A control edge 35 of the switching element 31 opens up an outflow bore 36. In this way, the oil situated in the first working chamber 29.1 can be displaced. At the same time, fresh oil is drawn into the second working chamber 29.2. The eccentric 5 can thus rotate in the direction of the arrow 37 in FIG. 1. If a drive unit force reverses before the second support piston 27.2 reaches the mechanical stop formed by a closure plug 38, a retraction movement briefly comes to a standstill, until a pressure force acts on the connecting rod 17 again. A rotation of the eccentric 5 in the opposite direction is not possible because the first working chamber 29.1 is closed and the first support piston 27.1 cannot retract. Depending on the configuration of one or more hydraulic resistances and a magnitude of the drive unit forces, a retraction process may therefore extend over multiple working cycles. The hydraulic resistance is preferably imparted by the connecting line or by a throttle point situated therein. An adjustment process preferably comes to an end when the second support piston 27.2 has arrived at the check valve 29.

This embodiment of a method, like the construction of the connecting rod, is merely exemplary and not restrictive. The support pistons used have a defined leakage path which, shown on an enlarged scale in FIG. 1A with regard to the first support piston 27.1, is made possible in the form of a special seal design of a sealing ring 40. The sealing ring 40 is composed of plastic and has a diagonal parting 41. By contrast, the second seal piston 27.2 does not have a sealing element, because the gap between the second seal piston 27.2 and the support cylinder forms the defined leakage path, as described above.

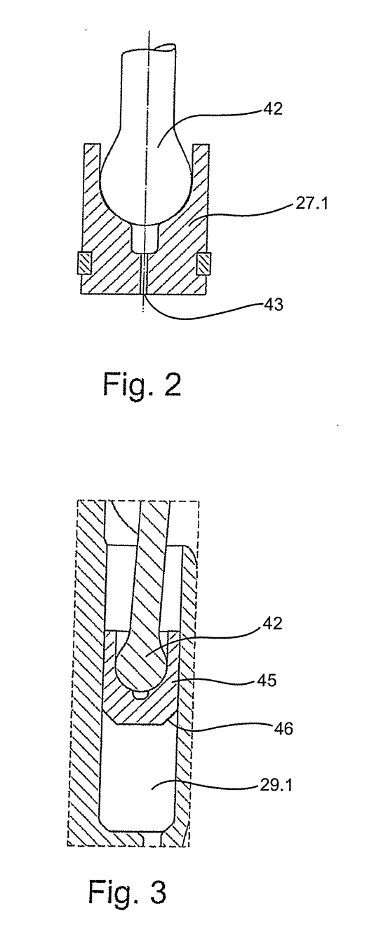

FIG. 2 shows an exemplary embodiment of a support piston with a ball head connection 42, wherein a ventilation bore 43 is arranged in the support cylinder.

FIG. 3 shows a further exemplary embodiment of a ball head connection 42 of the support cylinder 45, wherein the support cylinder 45 has a spherical end surface 46.

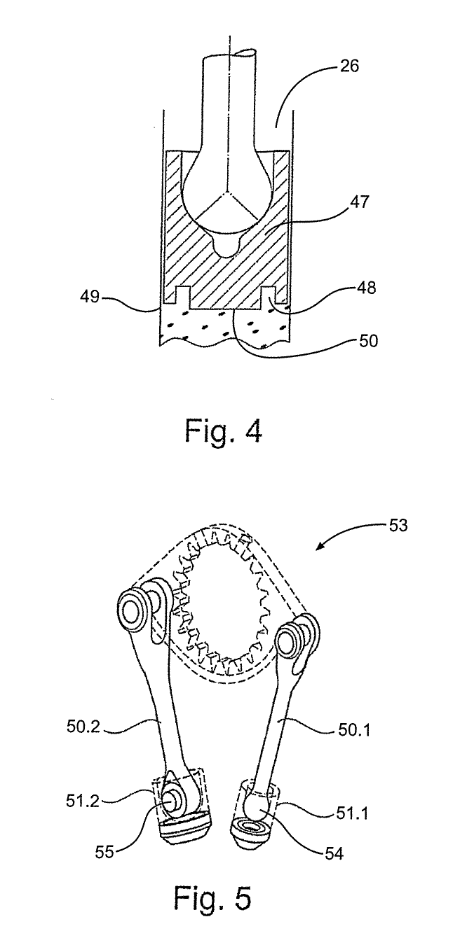

FIG. 4 shows an embodiment of a support cylinder 47 which has a contour which, under the action of pressure, leads to a constriction of the gap between support cylinder and support piston 47 as a result of flaring of the support piston. The contour on the end side, with its preferably encircling recess 48, makes it possible for the stiffness of the support piston at the end side 50 to be targetedly lowered at the outer circumference 49, such that the oil pressure leads to a small deformation of the support piston and thus reduces the clearance, wherein the reduction takes place in pressure-dependent fashion.

FIG. 5 shows, in an exemplary embodiment, an at least 2-stage VCR system based on the principle of a variable connecting rod length. For this purpose, an eccentric for receiving the piston pin is mounted pivotably in the small connecting-rod bearing eye. The gas and inertia forces acting on the piston lead to a moment acting on the eccentric. A support mechanism 53 having a lever, two support rods 50.1, 50.2 and two support pistons 51.1, 51.2 is connected to the eccentric member and transmits said moment to two support cylinders 52.1, 52.2 formed in the connecting rod. The support cylinder pointing in the eccentricity direction performs the support of the moments resulting from the gas forces, and the opposite cylinder performs the support of the inertia forces in an equivalent manner. Below, the two sides will therefore be referred to as “GFS”, for Gas Force Side, which is on the side of connecting rod 50.2, and “IFS”, for Inertia Force Side, which is on the side of connecting rod 50.1. Both support cylinders can, as required, be filled with oil from the crankpin bearing, and a check valve associated with each support cylinder prevents an outflow of the oil. By way of a 3/2 directional switching valve, for example, it is possible for the GFS or the IFS to be opened alternately. This combination of check valves and switching valves forms a hydraulic freewheel, the running direction of which is selectable. In the case of the position for a high compression ratio being selected, also referred to as “ε_high”, the mathematically positive moments acting on the eccentric are supported on the oil column of the GFS. In this position, the mathematically negatively acting moments arising from the inertia forces are transmitted, by way of direct metallic contact of the IFS support piston, to the connecting rod. In the position of a low compression ratio, referred to for short as “ε_low”, the conditions are reversed. A positive side-effect for the position “ε_low” is that the normally relatively high gas forces in said position are now no longer supported on the oil column, and thus the oil pressure in the support cylinder remains at a relatively low level. The adjustment system of the support system of said type is thus equipped with a first and a second support piston, wherein the two support pistons have different connections to the respective support rod: one support piston 50.1, which has a ball head connection 54, has a smaller support piston diameter than the other support piston 50.2, which has a bolted connection 55. The lever transmits the moment arising from the eccentricity, which moment may be greater than 300 Nm owing to the ever-increasing peak combustion pressures of modern, highly supercharged Otto-cycle engines, to the support rods. The transmission ratio defined by the ratio between eccentricity and lever length is approximately 1/10. In conjunction with the force action angle, which is dependent on the respective ε position, between support rods and levers, support forces thus arise which may by all means be as high as 10 kN. One preferred lever-side joint type is a classic bolt. This is fixedly connected to a structure of fork-like design at the upper end of the support rods and is mounted in the lever. The contact pressures that arise here amount to up to 200 MPa, for example. The point of articulation to the support pistons may likewise be in the form of a bolted bearing. The other preferred embodiment provides a ball joint. Firstly, this permits a relatively small support piston diameter, which, for the IFS, the forces of which are considerably lower than those on the GFS, has two positive side-effects:

The connecting rod is made lighter, because the structure around the support cylinder can be correspondingly re-drawn.

As small an IFS support piston diameter as possible gives rise, owing to the oil pressure, to a small but continuously acting moment on the eccentric in the direction of ε_high. This has a positive effect on the switching behavior at low engine speeds, because here, the moments arising from the inertia forces, which moments are required for the adjustment, are correspondingly low. Secondly, the omission of a bolt makes it possible to utilize the entire support piston height as a sealing length. This is preferred for the omission of additional sealing elements, because although the system exhibits a certain leakage—for example, owing to the lever ratio of approximately 1/10, a leakage-induced sinking of the support piston by 0.1 mm, for example, yields a change in the effective connecting rod length of only approximately 10 μm—the compression ratio can “drift” in an undesired manner if said leakage becomes too great. Likewise, the sealing elements generate an additional friction moment during an adjustment process. Thus, an adjustment can be initiated only if said moment is overcome. The sealing element may thus also comprise a sealing system composed of an O-ring and of a rectangular ring composed of a PTFE composite material situated above said O-ring. The friction thereof results, for example, in a breakaway torque of the eccentric of 0.5-0.8 Nm. This seemingly low moment level is however, in the presence of low engine speeds, only slightly exceeded for a switch in the direction of “E high” owing to the likewise very low inertia forces at said operating points. Since an only low excess moment is in turn associated with losses in switching speed, the abovementioned measures are therefore of great significance for these extreme operating points.

1. A piston engine comprising
a crankshaft,
at least one connecting rod which co-rotates with the crankshaft, wherein the connecting rod has a first eye and a second eye,
a compression chamber piston, which is arranged on the connecting rod and which is eccentrically adjustable by way of an eccentric member and an adjustment linkage, wherein the adjustment linkage is supported by way of at least one support piston which is movable in a support cylinder of the connecting rod, wherein
the support cylinder and the support piston form a targeted leakage path.

2. The piston engine preferably as claimed in claim 1, wherein the support piston is provided without a separate sealing element between support piston and support cylinder, and moves along the support cylinder without a sealing element.

3. The piston engine preferably as claimed in claim 1, wherein the support piston is equipped with a sealing element which permits targeted leakage, preferably via a parting in a joint region of the sealing element and via an axial clearance between, a height of the sealing element and a groove height of a groove in which the sealing element is arranged.

4. The piston engine as claimed in claim 3, wherein the support piston has one or more at least partially encircling channels along an outer circumference.

5. The piston engine as claimed in claim 1, wherein the support piston has a height which, in relation to a support piston diameter D, lies in a range from 0.8 to 1.5 D.

6. The piston engine preferably as claimed in claim 1, wherein the support piston is connected to an element of the adjustment linkage by way of a ball head connection.

7. The piston engine as claimed in claim 6, wherein the support piston has an internal contour of spherical form, against which a head of the ball head connection lies.

8. The piston engine preferably as claimed in claim 1, wherein the support piston has a geometry which permits flaring of the support piston upon exertion of pressure via the adjustment linkage, wherein a gap spacing between an internal surface of the support cylinder and an opposite external surface of the support piston is reduced.

9. The piston engine preferably as claimed in claim 1, wherein an end-side external contour of the support piston is spherical.

10. The piston engine preferably as claimed in claim 1, wherein the support piston has a ventilation bore extending all the way through, one end of which opens out, in a region of a piston end side of the support piston, into a first side of the support cylinder and the other end of which opens out into a second side of the support cylinder, wherein the first and the second side of the support cylinder are separated from one another by the support piston.

11. The piston engine as claimed in claim 1, wherein the internal combustion engine has an adjustable stroke for compression variation during operation through utilization of the at least one eccentrically adjustable combustion chamber piston, wherein at least one eccentric adjustment can be performed by way of gas and/or inertia forces acting on the at least one adjustment linkage.

12. The piston engine preferably as claimed in claim 1, wherein the connecting rod has a first and a second support piston which are connected to one another by way of the adjustment linkage, wherein the first support piston is connected to the adjustment linkage by way of a ball head connection, and the second support piston is connected to the adjustment linkage by way of a bolted connection.

13. The piston engine preferably as claimed in claim 1, wherein the connecting rod has a first and a second support piston which have different diameters in relation to one another, wherein the first support piston has a relatively small diameter and, between the first support piston and the first support cylinder associated therewith, there is a first gap which is larger than that between the second support piston and the second support cylinder associated therewith.

14. The piston engine as claimed in claim 1, wherein the support piston has, on its circumference, a coating, preferably a run-in coating, owing to which the support piston must firstly be forced under pressure into the support cylinder and which abrades during operation in order to thereby realize a gap between the support piston and the support cylinder, and/or preferably a protective coating which exhibits greater abrasion resistance than the support piston material itself.

15. A method for the adjustment of a compression of a piston engine preferably as claimed in one of the preceding claims by way of an eccentrically adjustable piston stroke, comprising:
adjusting of the piston stroke through the utilization of acting inertia and/or gas forces which, act on an adjustment linkage and on a support piston arranged on said adjustment linkage,
dampening the movement of the support piston in a support cylinder, the support cylinder, with oil of the piston engine as damping medium to counteract a movement of the support piston, by permitting flow between the support piston and the support cylinder along a targeted leakage path.

16. A method preferably as claimed in claim 15 for the adjustment of a compression of a piston engine, wherein the adjustment of the piston stroke takes place through the utilization of acting inertia and/or gas forces which, act on an adjustment linkage and on a support piston arranged on said adjustment linkage, wherein the support piston moves in a support cylinder, wherein, in the support cylinder, oil of the piston engine as damping medium counteracts a movement of the support piston, wherein, at a breakaway torque of 0.5 Nm or lower, friction between the support piston and support cylinder is overcome, and an adjustment of the support piston in the support cylinder takes place.
